(19) United States
(12) Patent Application Publication
(10) Pub. No.: US 2014/0360721 A1
(43) Pub. Date: Dec. 11, 2014

(54) CEMENT COMPOSITION WITH FLY ASH

(71) Applicant: CEMBLEND SYSTEMS INC., Calgary (CA)

(72) Inventors: Donald GETZLAF, Calgary (CA); Marty STROMQUIST, Calgary (CA); Ramkumar NATARAJAN, Trichy (IN)

(73) Assignee: CEMBLEND SYSTEMS INC., Calgary (CA)

(21) Appl. No.: 14/294,993

(22) Filed: Jun. 3, 2014

Related U.S. Application Data
(60) Provisional application No. 61/831,145, filed on Jun. 5, 2013.

(51) Int. Cl. C04B 7/26; E21B 33/13; C09K 8/42

(52) U.S. Cl. CPC C04B 7/26; C09K 8/42; E21B 33/13
USPC 166/293; 106/708; 106/706

(57) ABSTRACT

A cement composition comprising industrial waste containing calcium oxide and a retarder is disclosed. The cement composition is free of Portland cement. The composition also includes an alkali metal oxide, a hydrocarboxylic acid, and a sulphate compound. The cement may be used in methods for cementing subterranean formations such as oil and gas wells.

### CROSS-REFERENCE TO RELATED APPLICATIONS

This application claims the benefit of U.S. Provisional Application No. 61/831,145 filed Jun. 5, 2013, the entire disclosure of which is incorporated herein by reference.

### FIELD OF THE INVENTION

The present disclosure relates generally to a cement composition having a high proportion of an industrial waste material such as fly ash, and to a method of using the composition in subterranean formations. More particularly, the present invention relates to a cement composition with an industrial waste material such as fly ash and a retarder that affects the setting times.

### BACKGROUND OF THE INVENTION

Reservoir conditions are usually low pressure environments which require the use of light weight cement slurries for use in cementing the oil and gas wells. Generally, the cement is pumped into the annular space between the walls of the wellbore and the exterior of the casing or pipe. The cement is given adequate time to set in the annular space, thereby forming a sheath around the pipe. The cement helps to prevent migration of fluids between zones or formations penetrated by the wellbore and provide the necessary structural support for the well.

Light weight cements have been in existence for more than 40 years. Generally, these cements use Portland cement as the binding material, combined with extenders and water absorbing additives to control free water while lightening the slurry.

There are also cements that use low density solids such as gilsonite, Spherelite, and ceramic spheres to reduce density and absorb water. Still other light weight cements consist mainly of silica fume. Silica fume has the ability to bind much of the extra water and provide a cement of reasonable strength. However, cements with silica fume may have handling problems, may cause health hazards and may have quality control issues.

The use of fly-ash in cement compositions is known. Fly ash is a “pozzolan”, meaning it is a material containing silica, alumina and calcium that in the presence of water will react with either the free lime (i.e. calcium hydroxide) in the fly ash itself or with other components to produce a cement material. The amount of silica, alumina and iron varies depending on the type of fly ash. Some fly ashes contain sufficient calcium compounds to be self-hardening while other fly ashes do not have enough calcium compounds to be self-hardening. The latter fly ashes require the addition of calcium compounds to impart the desired strength.

Many of the cement compositions comprising fly ash include the presence of Portland cement. For example, U.S. Pat. No. 5,556,458 discloses a composition comprising at least 20% Portland cement. The presence of Portland cement is required to overcome the low early strength of fly ash compositions. U.S. Pat. No. 4,997,484 and U.S. Pat. No. 7,288,148 disclose fly-ash cement compositions without Portland cement but which rely on an acid-base reaction system that utilizes the combined effects of citric acid (approximate pH of 2.2) and either an alkali metal carbonate (approximate pH 12-14) or metal carbonate (approximate pH 11.6).

Because of the high volume of cement being used in well completion operations, there is a need to be able to economically produce large quantities of cement. To produce typical cements such as Portland cements, there are a number of extremely energy intensive steps including milling, heating, mixing, etc. that must be performed to obtain the finished cement ready for use. In fact, the production of cements is the third largest producer of carbon dioxide emissions, which is well known to be the primary gas involved in global warming, because of its dependency on fossil fuels to accomplish those steps.

Fly ash can cause waste disposal problems. Thus, it is desirable to have recycling uses for the fly ash. Further, the cement must have other properties such as appropriate setting time, good chemical resistance, a broad operating temperature range and high compressive strength. It is, therefore, desirable to provide a cement that can be cost-effectively produced, that has the desired pouring times for use in subterranean formations, and that has the desired strength, temperature resistance and hardness.

### SUMMARY OF THE INVENTION

The present invention relates to cement compositions made from industrial waste material containing calcium oxide, such as high fly ash.

According to a first aspect, the present invention provides a cement composition comprising an industrial waste material comprising calcium oxide, an alkali metal oxide compound, a sulphate compound, a hydrocarboxylic acid compound, an alkali metal carbonate and a retarder. Preferably, the cement composition comprises a retarder that allows for the desired setting time. The cement composition can be economically manufactured, and has properties that make the cement ideal for use in cementing casing and/or lining subterranean formations such as oil and gas wells. Preferably, the retarder may be cream of tartar.

Also preferably, the industrial waste material is fly ash, present in a range of 20-95% by weight of the cement composition. In some embodiments, the fly ash can be present in a range of 88-95% by weight of the cement composition.

In one embodiment, the cement composition may additionally comprise a light weight material selected from the group consisting of: Spherelite, vermiculite, perlite, zeolites, metakaolin or a silica fume.

According to an aspect of the present invention, there is provided a cement composition, free of Portland cement, said composition comprising: industrial waste comprising calcium oxide; an alkali metal oxide compound; a sulphate compound; a hydrocarboxylic acid compound; and a retarder. Preferably, the composition also comprises an alkali metal carbonate.

Preferably, the industrial waste is selected from the group consisting of: C fly ash, blast furnace slag, calcium silicate, di-calcium silicate, copper slag or cement kiln, or a combination thereof. Preferably, the industrial waste comprises 20-95% by weight of the composition. Preferably, the industrial waste is fly ash. More preferably, the fly ash is present in an amount ranging from 88-95% by weight of the composition.

Preferably, the alkali metal oxide compound is calcium oxide.

Also preferably, the sulphate compound is selected from the group consisting of: sodium sulphate, potassium sulphate, calcium sulphate, or iron sulphate, or mixtures thereof. More preferably, the sulphate compound is present in an amount ranging from 0.5-15% by weight of the composition. Even more preferably, the sulphate compound is present in an amount ranging from 0.5-10%.

Further preferably, the hydrocarboxylic acid is selected from the group consisting of: citric acid, lactic acid, malic acid, benzoic acid, acetic acid, and salts thereof.

Preferably, the cement composition further comprises a light weight additive selected from the group consisting of: Spherelite, vermiculite, perlite, zeolites, metakaolin, and silica fume. More preferably, the light weight additive is present in an amount ranging from 0.5 to 15% by weight of the composition.

Preferably, the cement composition has a setting time ranging from about 2 to about 5 hours after mixing with water.

According to another aspect of the invention, there is provided for a method for cementing a subterranean formation, comprising: introducing a cement composition into the subterranean formation, said cement composition comprising an industrial waste compound comprising calcium oxide, water, a sulphate compound, a retarder, a hydrocarboxylic acid, and an alkali metal compound; and allowing the cement composition to set within the subterranean formation. Preferably, the cement is allowed to set for a period ranging from 2 to 5 hours. Preferably also, the subterranean formation is an oil or gas well.

Also preferably, the cement composition has a strength ranging from 800 to 1500 psi after 72 hours after the composition has set.

Other aspects and features of the present invention will become apparent to those ordinarily skilled in the art upon review of the following description of specific embodiments of the invention in conjunction with the accompanying figures.

### DETAILED DESCRIPTION OF PREFERRED EMBODIMENTS OF THE INVENTION

According to a preferred embodiment of the present invention, there is provided for a cement composition containing industrial waste comprising calcium oxide along with additional chemical compounds, such as an alkali metal oxide, a hydrocarboxylic acid, a sulphate source and a retarder. In some embodiments, the cement composition may additionally comprise an alkali metal carbonate such as bicarbonate. In addition, the cement composition may contain a light-weight additive such as Spherelite, vermiculite, perlite, zeolites, metakaolin, or silica fume. The cement of the present application may be used to cement oil wells with low formation pressures.

In the present cement composition, the presence of calcium oxide in the industrial waste imparts strength to the resulting cement. Unlike other industrial waste-based cements which require the addition of Portland cement to impart strength, the present composition does not require any Portland cement. Additionally, the presence of a retarder has the effect of increasing the setting time of the resulting slurry, which makes it ideal for use in applications such cementing and/or repairing cement in oil and gas wells, as well as any subterranean formation. Generally, the cement of the present application has a setting time of anywhere between 2 to 5 hours. The cement composition can be cost-effectively produced, due to the large volumes of water involved in its preparation and due in part to the low-cost of the industrial waste. Further, much less carbon dioxide is released during the preparation of the present cement, compared to Portland cement which requires great amounts of energy to produce and releases a lot of carbon dioxide. This makes the composition environmentally friendly.

The method of using the present composition in subterranean formations generally comprises the steps of preparing the cement composition, introducing the cement into the wellbore and allowing the cement composition to set after being poured down the wellbore.

Without being bound by theory, the presence of the alkali metal oxide and the sulphate compound increases the pH of the slurry so as to dissolve aluminate and silicate present in the industrial waste, which in turn reacts with the calcium in the oxide to form ettringite and other compounds. These compounds have the effect of converting the composition into a hardened mass. Thus, the presence of calcium oxide increases the strength of the cement, without requiring the addition of Portland cement to the cement composition. There are several known types of Portland cement generally having the same elements present in varying amounts, but all having very low CaO levels, generally in the range of 1% by weight of the Portland cement composition.

The industrial waste material may be any industrial waste material having the appropriate amount of calcium oxide. Examples include C fly ash, blast furnace slag, calcium silicate, di-calcium silicate, copper slag and cement kiln dust, or a combination of any of these materials with class F fly ash or magnesium silicate. As one skilled in the art would appreciate, the fly ash can be collected from combustion gases for example coal or other industrial sources. The industrial waste may be present in the range of 20-95% weight of the cement composition. In some embodiments, the industrial waste can be present in 50-95% weight of the cement composition. In still other embodiments, the industrial waste can be present in 70-95% of the weight of the cement composition. In yet other embodiments, the industrial waste can be present in an amount as high as 88-95% weight of the cement composition. The amount of industrial waste can be varied depending on the properties of the waste itself, and the amounts and proportions of other components with which the waste is mixed in the composition. For example, the addition of other calcium-containing compounds may decrease the amount of calcium oxide needed in the industrial waste (e.g. if calcium lactate is added to the cement composition, for example). Generally, the industrial waste is chosen such that its calcium oxide content is 5-50% weight of the waste material.

A cement composition according to the present application includes an alkali metal compound. Generally, the alkali metal compound may be selected from calcium oxide, calcium hydroxide, magnesium oxide, sodium hydroxide, and potassium hydroxide. In some embodiments, the calcium oxide is high purity lime. The alkali metal oxide has the effect of increasing the pH of the composition. The increase in the pH allows for more silica in the industrial waste to dissolve and this increases the strength of the resulting cement.

The sulphate compound of the present cement composition may be, for example, sodium sulphate, potassium sulphate, calcium sulphate or iron sulphate. The proportion of sulphate compound can vary, but typically, the sulphate compound is present in the range of 1-15% weight of the cement composition. As would be appreciated by someone skilled in the art, the amount of sulphate compound can be adjusted to achieve the desired strength characteristics.

The present composition includes a hydrocarboxylic acid, by which it is generally meant the alkali metal salt of a hydrocarboxylic acid. The salt may be selected from the group consisting of:

citrate, lactate, malate, benzoate, and acetate. The hydrocarboxylic acid can also be used alone in some embodiments (for example, lactic acid, citric acid, or acetic acid can be used, without the salt). The hydrocarboxylic acid is generally present in the range of 0.5 to 10% weight of the cement composition and serves as an activator.

The primary function of a retarder is to keep the slurry from stiffening too rapidly, thereby promoting chemical and physical reaction between chemical components. Additional functions and benefits of the retarder is a reduction in the amount of water and the ability to make the slurry the appropriate consistency. The retarder can be any retarder that is known in the industry to increase the setting time of the cement. Suitable retarders include cream of tartar, boric acid, and the like. The retarder may be present in the range of 0.5 to 5% weight of the cement composition.

The composition can also include light weight additives such as Spherelite, vermiculite, perlite, zeolites, metakaolin or silica fume. The light weight additive may be present in the range of 0.5 to 15% weight of the cement composition. The effect of the light weight additive is to further lighten the weight of the cement slurry. Those of skill in the art will appreciate that various additional cement additives may be used with the present application to arrive at desired commercial properties.

Water is needed to hydrate the dry components. The amount of water needed varies depending on the desired workability of the slurry and the individual components present in the composition. Generally, it is desirable to use high proportions of water in creating the slurry because water has the effect of lightening the slurry and water is relatively inexpensive compared to other components typically found in cement compositions.

The method of using the composition includes the step of introducing the cement composition into the subterranean formation (which can include a well, such as an oil, gas or water well). The composition or slurry will be poured into the well, likely the wellbore annulus. The step of introducing the composition into the annulus can include well completion, primary or remedial cementing operations, well-plugging or gravel-packing. The cement composition is in a pumpable state upon introduction to the formation. The method further includes the step of allowing the composition to harden or set after introduction into the wellbore. The method may also include the step of perforating, fracturing, acidifying, etc, after the cement has been allowed to set. Setting times vary, but generally the cement is allowed to set for at least 2 hours. Further increases in strength are observed after longer setting times. The setting time is also a function of properties such the temperature and pressure of the wellbore, and the amount of fluid in the wellbore.

In the embodiments of the present application, the amounts of each component are chosen such that the cement has a pouring time of around 2-5 hours, and in many embodiments, the setting time is between 2-3 hours. As a person skilled in the art would appreciate, the pouring time varies depending on the depth of the formation to which the slurry is applied.

### Preparation of Cement Compositions

Tables 1 and 2 show various examples of the compositions. These examples are not intended to be limiting, and are included for illustrative purposes. Table 1 shows the proportion of each component in absolute terms. Table 2 shows the properties of the mixtures, such as setting time, slurry density and strength.

TABLE 1
Composition of Various Cement Mixtures

| | | | Cream | | | | |
|---|---|---|---|---|---|---|---|
| | | Calcium | of | Sodium | Calcium | | |
| | C-Ash | Lactate | Tartar | Sulphate | Oxide | Water | Metakaolin |
| Mixture | (g) | (g) | (g) | (g) | (g) | (g) | (g) |
| 1 | 970 | 30 | 2 | ( ) | 0 | 340 | 0 |
| 2 | 950 | 30 | 2 | ( ) | 20 | 340 | 0 |
| 3 | 910 | 30 | 2 | 40 | 20 | 340 | 0 |
| 4 | 910 | 30 | 3.5 | 40 | 20 | 340 | 0 |
| 5 | 880 | 30 | 3.5 | 30 | 20 | 340 | 30 |

TABLE 2
Properties of Various Cement Mixtures Set out in Table 1

| | | Strength at | | |
|---|---|---|---|---|
| | Slurry Density | 24 hours | Strength at 72 | |
| Mixture | (g/mL) | (psi) | hours (psi) | Setting Time |
| 1 | 1.72 | 450 | 1216 | 1 hr. 15 min. |
| 2 | 1.72 | 650 | 1312 | 1 hr. 15 min. |
| 3 | 1.72 | 950 | 1615 | 2 hr. 15 min. |
| 4 | 1.72 | 850 | N/A | 2 hr. 15 min. |
| 5 | 1.72 | 800 | 1128 | 2 hr. 15 min. |

To arrive at composition illustrating preferred embodiments of the present invention, the dry components were added to a Hobart mixer, water was subsequently added and the resulting slurry was mixed for 10 minutes at 150 rpm. A sample was removed to determine slurry density and the slurry was then poured into 50 mm cubes and allowed to harden or set at room temperature. After a period of 24 hours, the strength of the cement was measured. The strength was again determined after 72 hours. The compositions according to the examples set out above were allowed to set at 77 F. An increase in setting temperature will shorten the setting time. Compressive strength was measured according to ASTM C39.

Examples of the cement composition of the present invention were tested for strength and setting time. In comparing Mixtures 1 and 2 listed in Table 1, Mixture 2 includes calcium oxide. The slurry strength after a period of 24 hours following pouring was 450 pounds per square inch (psi) for Mixture 1 and 650 psi for Mixture 2. These results suggest that the calcium oxide increases the strength of cement.

Comparing Mixture 3 with Mixture 2, the addition of sodium sulphate had the effect of increasing the strength after a 24-hour period, from 650 psi to 950 psi. The strength after 72 hours was 1156 psi. This further increase in strength of the cement after the initial 24 hour period is commonly observed with other cement compositions. In Mixtures 1, 2 and 3, no retarder was included in the composition. The setting time was 1 hour and 15 minutes.

In Mixture 4, lime or calcium hydroxide was added as the source of an alkali metal oxide. Cream of tartar was added to the composition. The setting time of Mixture 4 was 2 hours and 15 minutes, one hour more than the setting time of Mixture 3. This increase in setting time is due to the addition of the retarder. The strength of Mixture 4 is 850 psi, comparable to the strength of Mixture 3.

Comparing Mixtures 4 and 5, Mixture 5 includes the light weight additive metakaolin. The setting time of Mixture 5 was the same as the setting time of Mixture 4 and the strength was similar. This indicates that the presence of the light weight additive does not significantly impact the strength, while still having the effect of making the composition lighter.

The above-described embodiments of the present invention are intended to be non-limiting examples only. Alterations, modifications and variations may be effected to the particular embodiments by those of skill in the art without departing from the scope of the invention, which is defined solely by the claims appended hereto.

What is claimed is:

1. A cement composition, free of Portland cement, said composition comprising:
industrial waste comprising calcium oxide;
an alkali metal oxide compound;
a sulphate compound;
a hydrocarboxylic acid compound; and
a retarder.

2. The composition of claim 1, additionally comprising an alkali metal carbonate.

3. The cement composition of claim 1, wherein the industrial waste is selected from the group consisting of: C fly ash, blast furnace slag, calcium silicate, di-calcium silicate, copper slag or cement kiln, or a combination thereof.

4. The cement composition of claim 1, wherein the industrial waste comprises 20-95% by weight of the composition.

5. The cement composition of claim 1, wherein the industrial waste is fly ash.

6. The cement composition of claim 5, wherein the fly ash is present in an amount ranging from 88-95% by weight of the composition.

7. The cement composition of claim 1, wherein the alkali metal oxide compound is calcium oxide.

8. The cement composition of claim 1, wherein the sulphate compound is selected from the group consisting of: sodium sulphate, potassium sulphate, calcium sulphate, or iron sulphate, or mixtures thereof.

9. The cement composition of claim 1, wherein the sulphate compound is present in an amount ranging from 1-15% by weight of the composition.

10. The cement composition of claim 1, wherein the hydrocarboxylic acid is selected from the group consisting of: citric acid, lactic acid, malic acid, benzoic acid, acetic acid, and salts thereof.

11. The cement composition of claim 1, wherein the retarder is cream of tartar.

12. The cement composition of claim 1, further comprising a light weight additive selected from the group consisting of: Spherelite, vermiculite, perlite, zeolites, metakaolin, and silica fume.

13. The cement composition of claim 12, wherein the light weight additive is present in an amount ranging from 0.5 to 15% by weight of the composition.

14. The cement composition of claim 1, wherein said cement has a setting time ranging from about 2 to about 5 hours after mixing with water.

15. A method for cementing a subterranean formation, comprising:
introducing a cement composition into the subterranean formation, said cement composition comprising an industrial waste compound comprising calcium oxide, water, a sulphate compound, a retarder, a hydrocarboxylic acid, and an alkali metal compound; and
allowing the cement composition to set within the subterranean formation.

16. The method of claim 15, wherein the cement is allowed to set for a period ranging from 2 to 5 hours.

17. The method of claim 15, wherein the cement composition is as defined in any one of claims 1 to 14.

18. The method according to claim 15, wherein the subterranean formation is an oil or gas well.

19. The method of claim 15, wherein the cement composition has a strength ranging from 800 to 1500 psi after 72 hours after the composition has set.
